(19) United States
(12) Patent Application Publication
(10) Pub. No.: US 2026/0038221 A1
(43) Pub. Date: Feb. 5, 2026

(54) METHOD AND APPARATUS FOR IMPLEMENTING ENHANCED VIRTUAL DIGITAL REPRESENTATION IN METAVERSE

(71) Applicant: SAMSUNG ELECTRONICS CO., LTD., Suwon-si (KR)

(72) Inventors: Yanli WANG, Nanjing (CN); Bo Peng, Nanjing (CN); Degui You, Nanjing (CN)

(73) Assignee: SAMSUNG ELECTRONICS CO., LTD., Suwon-si (KR)

(21) Appl. No.: 19/357,745

(22) Filed: Oct. 14, 2025

Related U.S. Application Data
(63) Continuation of application No. PCT/KR2024/005603, filed on Apr. 25, 2024.

(30) Foreign Application Priority Data
Apr. 26, 2023 (CN) 202310460783.0

(51) Int. Cl. G06T 19/20; G06T 17/00

(52) U.S. Cl. CPC G06T 19/20; G06T 17/00; G06T 2219/2024

(57) ABSTRACT

A method for implementing enhanced virtual digital representation in a metaverse includes monitoring attribute information of a virtual digital object and user information of at least one user in a scenario, obtaining, based on the attribute information, state decision data of the virtual digital object, determining, based on the state decision data and the user information, whether an interaction with a user in the scenario needs to be triggered, and notifying, based on determining that the interaction with the user needs to be triggered, the user of the state decision data of the virtual digital object by interacting with the user using a virtual avatar.

### CROSS-REFERENCE TO RELATED APPLICATIONS

This application is a continuation application of International Application No. PCT/KR2024/005603, filed on Apr. 25, 2024, which claims priority to Chinese Patent Application No. 202310460783.0, filed on Apr. 26, 2023, in the China National Intellectual Property Administration, the disclosures of which are incorporated by reference herein in their entireties.

### BACKGROUND

### 1. Field

The present disclosure relates generally to artificial intelligence technology, and more particularly, to a method and apparatus for implementing enhanced virtual digital representation in metaverse.

### 2. Description of Related Art

A digital twin may refer to a virtual representation of an object and/or system throughout its life cycle, updated by real-time data, which may use simulation, machine learning, and/or inference to assist in decision-making. An object state may be collected through various sensors (e.g., Internet of Things (IoT) devices), which may be automatically recognized through computer vision (CV) and/or knowledge base (KB) inferring technologies, and may be mapped and/or jointly influenced with a virtual object in a metaverse. The digital twin may be and/or may include a digital representation of a physical object, process, and/or service, and may be a digital duplicate of an object in the physical world, such as, but not limited to, a jet engine, a wind power plant, or the like. The digital may also be a digital duplicate of a larger object and/or collection of objects, such as, but not limited to, a building or an entire city.

Recently, digital twins may have been used in many fields such as, but not limited to, industrial and/or agricultural production, healthcare services, or the like. For example, in some intelligent and/or precision plant cultivation methods, digital twin technologies may be used to quantify a variety of state information of plants and visualize output through various graphs and tables.

As another example, in industrial production, digital twins may be used to represent real products. The virtual representation of a product may not only have the same geometric shape as the real product, but may also behave and/or perform under the same physical rules and/or mechanisms in order to simulate the entire life cycle of the product. The use of digital twins in production may provide for relatively more effective research and/or design of products, and may provide for the creation of rich data about possible performance results. The information may assist enterprises to potentially improve products before production.

As another example, in healthcare services, similar to the use of digital twins to analyze products, corresponding virtual representations for patients receiving healthcare services may also be generated based on digital twin technologies. In addition, similar sensor-generated system data may be used for tracking various health indicators and potentially generating key insights.

However, related digital twin implementation schemes may be limited by relatively high professional requirements, passive interaction with users, and/or lack of intelligence. For example, in related digital twin implementation schemes, when a virtual digital object communicates with a user in an application scenario, the user may be presented with parameter information used for describing a real object state, which the user may be unable to use to comprehend or analyze the state of the virtual object, and as such, may be unable to provide corresponding operation suggestions. That is, the user may be expected to have a relatively high level of knowledge in the corresponding field, so as to analyze the current state of the virtual digital object and provide subsequent operations to be performed based on the information output by the virtual digital object. In addition, the communication between the virtual digital object and the user may be passive, and the collected information may only be provided to the user based on a request from the user (e.g., the user may active a trigger).

The virtual digital object may represent a real object by using the same geometric shape, the same physical/chemical/operational rules and mechanisms, and may simulate the real object throughout the entire life cycle. That is, the virtual digital object may be simulated and/or operated in similar ways to the real world object, and may have similar abilities to the real object, such as, but not limited to, an expression ability, a communication ability, or the like. Consequently, users may interact with virtual digital objects in a manner similar to how the users may interact with real objects in the real world. However, such a communication mode between users and objects may be limited. For example, communications between users and objects may not achieve intelligent effects similar to interactions between natural people (e.g., humans). For example, unlike humans, virtual digital objects may not use different expressions and/or content to communicate with users based on different dialog objects, so as to give the other party a communication experience human interaction.

Thus, there exists a need for further improvements in digital twin technologies, as the need for improved interactions between virtual digital objects and users may be constrained by expectations for users to have a relatively high level of knowledge in the corresponding field, limits in the communication mode between users and the virtual digital objects, an inability of virtual digital objects to actively interact with users, and interactions between virtual digital objects and users that may lack intelligence.

### SUMMARY

One or more example embodiments of the present disclosure provide an implementation method and apparatus for implementing enhanced virtual digital representation in metaverse, which may reduce professional requirements for a user to communicate with a virtual digital object, improve the intelligence of interaction with the user, and facilitate the user to obtain a surreal application experience.

According to an aspect of the present disclosure, a method for implementing enhanced virtual digital representation in a metaverse includes monitoring attribute information of a virtual digital object and user information of at least one user in a scenario, obtaining, based on the attribute information, state decision data of the virtual digital object, determining, based on the state decision data and the user information, whether an interaction with a user in the scenario needs to be triggered, and notifying, based on determining that the interaction with the user needs to be triggered, the user of the state decision data of the virtual digital object by interacting with the user using a virtual avatar.

In an embodiment, the method may further include identifying, based on the attribute information, a current scenario type, and identifying, based on the user information, a role type of each user of the at least one user in the scenario.

In an embodiment of the method, the state decision data may include at least one of current state data, future state data, requirements, or suggestion information, the interacting with the user may include generating, using a preset virtual avatar generator and a user dialog system, the virtual avatar based on the state decision data, the role type, and the current scenario type, and the method may further include performing, using the user dialog system, at least one of natural language understanding, automatic speech recognition, or text speech synthesis.

In an embodiment, the interacting with the user may include customizing at least one of an appearance, a pose, an emotional expression, or a voice of the virtual avatar, based on the state decision data, the role type, and the current scenario type.

In an embodiment of the method, the attribute information may include self-feature information of the virtual digital object and feature information of an environment where the virtual digital object is located, and the environment may include at least one of a micro-environment or a macro-environment.

In an embodiment, the monitoring of the attribute information of the virtual digital object may include identifying a type of an entity corresponding to the virtual digital object, obtaining a corresponding set of object attributes based on the type of the entity, and obtaining corresponding attribute values for the virtual digital object based on attributes indicated by the corresponding set of object attributes to obtain the attribute information of the virtual digital object.

In an embodiment, the method may further include obtaining the current state data of the virtual digital object based on the attribute information in a state inferring manner by using a preset knowledge base or rule base.

In an embodiment, the method may further include obtaining the current state data of the virtual digital object based on the attribute information by using a pre-trained state inference model.

In an embodiment, the method may further include obtaining, by using a pre-trained state prediction model, the future state data of the virtual digital object based on at least one of the attribute information of the virtual digital object or historical attribute information of the virtual digital object within a specified historical time period.

In an embodiment, the determining whether the interaction with the user in the scenario needs to be triggered may include, based on state data indicating that the virtual digital object is in an abnormal state, determining that the interaction with the user in the scenario needs to be triggered, and, based on a distance between the user and an entity corresponding to the virtual digital object being within a preset range, determining that the interaction with the user in the scenario needs to be triggered. The state data may include the current state data and the future state data.

In an embodiment, the interacting with the user may further include obtaining the virtual avatar for the virtual digital object by using the preset virtual avatar generator based on at least one of a type of an entity corresponding to the virtual digital object, the state decision data, the role type, the current scenario type, or preset virtual avatar style configuration data, obtaining, for the virtual avatar, a first dialog sentence for the interaction with the user by using the user dialog system based on the state decision data, the role type, and the current scenario type, and outputting the first dialog sentence by using the virtual avatar, and, based on a second dialog sentence being detected from the user, updating the preset virtual avatar style configuration data of the virtual avatar by using the preset virtual avatar generator based on current dialog context, the state decision data, the role type, and the current scenario type, and obtaining a matching reply sentence for the virtual avatar by using the user dialog system.

According to an aspect of the present disclosure, an apparatus for implementing enhanced virtual digital representation in a metaverse includes one or more processors including processing circuitry, and memory storing instructions. The instructions, when executed by the one or more processors individually or collectively, cause the apparatus to monitor attribute information of a virtual digital object and user information of at least one user in a scenario, obtain, based on the attribute information, state decision data of the virtual digital object, determine, based on the state decision data and the user information, whether an interaction with a user in the scenario needs to be triggered, and notify, based on a determination that the interaction with the user needs to be triggered, the user of the state decision data of the virtual digital object by interacting with the user using a virtual avatar.

In an embodiment, the instructions, when executed by the one or more processors individually or collectively, may further cause the apparatus to identify, based on the attribute information, a current scenario type, and identify, based on the user information, a role type of each user of the at least one user in the scenario.

In an embodiment, the state decision data may include at least one of current state data, future state data, requirements, or suggestion information. The instructions, when executed by the one or more processors individually or collectively, may further cause the apparatus to generate, using a preset virtual avatar generator and a user dialog system, the virtual avatar based on the state decision data, the role type, and the current scenario type, and perform, using the user dialog system, at least one of natural language understanding, automatic speech recognition, or text speech synthesis.

In an embodiment, the instructions, when executed by the one or more processors individually or collectively, may further cause the apparatus to customize at least one of an appearance, a pose, an emotional expression, or a voice of the virtual avatar is customized, based on the state decision data, the role type, and the current scenario type.

In an embodiment, the attribute information may include self-feature information of the virtual digital object and feature information of an environment where the virtual digital object is located, and the environment may include at least one of a micro-environment or a macro-environment.

In an embodiment, the instructions, when executed by the one or more processors individually or collectively, may further cause the apparatus to identify a type of an entity corresponding to the virtual digital object, obtain a corresponding set of object attributes based on the type of the entity, and obtain corresponding attribute values for the virtual digital object based on attributes indicated by the corresponding set of object attributes, so as to obtain the attribute information of the virtual digital object.

In an embodiment, the instructions, when executed by the one or more processors individually or collectively, may further cause the apparatus to obtain the current state data of the virtual digital object based on at least one of the attribute information in a state inferring manner by using a preset knowledge base or rule base, or on the attribute information by using a pre-trained state inference model.

In an embodiment, the instructions, when executed by the one or more processors individually or collectively, may further cause the apparatus to obtain, by using a pre-trained state prediction model, the future state data of the virtual digital object based on at least one of the attribute information of the virtual digital object or historical attribute information of the virtual digital object within a specified historical time period.

In an embodiment, the instructions, when executed by the one or more processors individually or collectively, may further cause the apparatus to, based on state data indicating that the virtual digital object is in an abnormal state, determine that the interaction with the user in the scenario needs to be triggered, and, based on a distance between the user and an entity corresponding to the virtual digital object being within a preset range, determine that the interaction with the user in the scenario needs to be triggered. The state data may include the current state data and the future state data.

According to an aspect of the present disclosure, a computer-readable storage medium storing computer-readable instructions for implementing enhanced virtual digital representation in a metaverse that, when executed by at least one processor of an apparatus, cause the apparatus to monitor attribute information of a virtual digital object and user information of at least one user in a scenario, obtain, based on the attribute information, state decision data of the virtual digital object, determine, based on the state decision data and the user information, whether an interaction with a user in the scenario needs to be triggered, and notify, based on a determination that the interaction with the user needs to be triggered, the user of the state decision data of the virtual digital object by interacting with the user using a virtual avatar.

According to an aspect of the present disclosure, a computer program product, including a computer program/instructions for implementing enhanced virtual digital representation in metaverse that, when executed by at least one processor of an apparatus, cause the apparatus to monitor attribute information of a virtual digital object and user information of at least one user in a scenario, obtain, based on the attribute information, state decision data of the virtual digital object, determine, based on the state decision data and the user information, whether an interaction with a user in the scenario needs to be triggered, and notify, based on a determination that the interaction with the user needs to be triggered, the user of the state decision data of the virtual digital object by interacting with the user using a virtual avatar.

Further, one or more example embodiments of the present disclosure provide for the collection of attributes of a virtual digital object and user information in a scenario in real time, and the analysis and determination of a state of the virtual digital object based on the collected information, which provides for the automatic perception on the virtual digital object and intelligent decision-making on its operation, thereby potentially enhancing the intelligence of interaction between the virtual digital object and a user, and potentially reducing professional knowledge requirements for the user during interaction with the virtual digital object.

Further, one or more example embodiments of the present disclosure provide for the time of interaction with the user to be autonomously recognized based on the collected information and the analysis results, and when interaction is needed, the interaction with the corresponding user may be implemented in a virtual avatar manner based on the state decision data, the role type, and the scenario type, so that the way and content of the interaction with the user are more intelligent. For example, stylization data of a virtual avatar may be generated based on the state decision data and the role type, so that the display style of the virtual avatar matches the user role, and the user may obtain an enhanced application experience.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a schematic flowchart of an implementation method for implementing enhanced virtual digital representation in metaverse, according to an embodiment of the present disclosure;

FIG. 2 is an example diagram of current state inference, according to an embodiment of the present disclosure;

FIG. 3 is an example diagram of future state prediction, according to an embodiment of the present disclosure;

FIG. 4 is an example diagram of user identity recognition, according to an embodiment of the present disclosure;

FIG. 5 is an example diagram of generating different virtual avatars for different users, according to an embodiment of the present disclosure;

FIGS. 6 to 13 are example diagrams of applications in specific scenarios, according to embodiments of the present disclosure; and

FIG. 14 is a schematic structural diagram of an implementation apparatus for implementing enhanced virtual digital representation in metaverse, according to an embodiment of the present disclosure.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

It is to be understood that when an element or layer is referred to as being “over,” “above,” “on,” “below,” “under,” “beneath,” “connected to” or “coupled to” another element or layer, it may be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

The terms “upper,” “middle”, “lower”, or the like may be replaced with terms, such as “first,” “second,” third” to be used to describe relative positions of elements. The terms “first,” “second,” third” may be used to describe various elements but the elements are not limited by the terms and a “first element” may be referred to as a “second element”. Alternatively or additionally, the terms “first”, “second”, “third”, or the like may be used to distinguish components from each other and do not limit the present disclosure. For example, the terms “first”, “second”, “third”, or the like may not necessarily involve an order or a numerical meaning of any form.

As used herein, when an element or layer is referred to as “covering”, “overlapping”, or “surrounding” another element or layer, the element or layer may cover at least a portion of the other element or layer, where the portion may include a fraction of the other element or may include an entirety of the other element. Similarly, when an element or layer is referred to as “penetrating” another element or layer, the element or layer may penetrate at least a portion of the other element or layer, where the portion may include a fraction of the other element or may include an entire dimension (e.g., length, width, depth) of the other element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, or the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

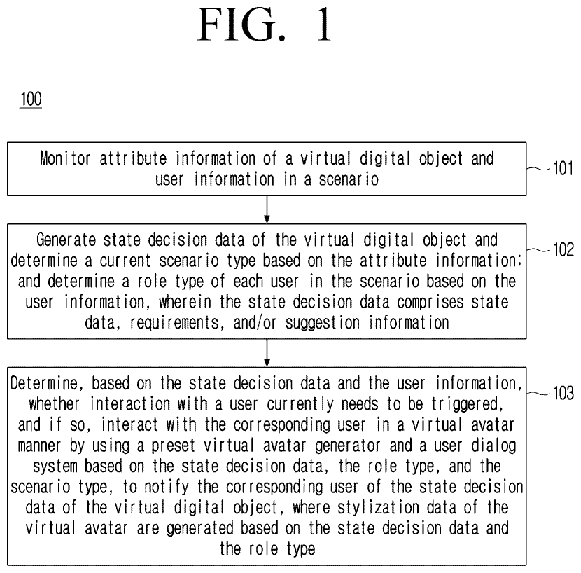

FIG. 1 is a schematic flowchart of an implementation method for implementing enhanced virtual digital representation in metaverse, according to an embodiment of the present disclosure. Referring to FIG. 1, an implementation method 100 for implementing enhanced virtual digital representation in metaverse that realizes one or more aspects of the present disclosure is illustrated.

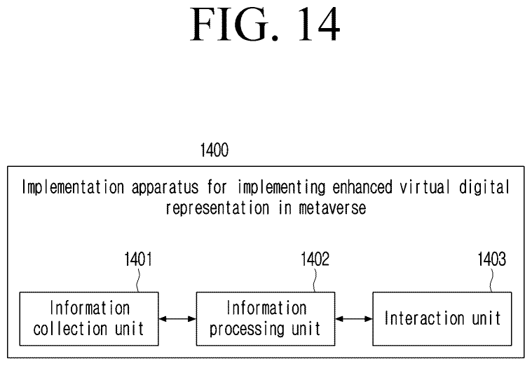

In some embodiments, at least a portion of the implementation method 100 may be performed by an apparatus (e.g., apparatus 1400 of FIG. 14). Alternatively or additionally, another computing device (e.g., an electronic device, a server, a laptop, a personal computer (PC), a smartphone, a user equipment (UE), a camera, a wearable device, a smart device, an Internet of Things (IoT) device, or the like) may perform at least a remaining portion of the implementation method 100. For example, in some embodiments, the apparatus and the other computing device may perform the implementation method 100 in conjunction. That is, the apparatus may perform a portion of the implementation method 100 and a remaining portion of the implementation method 100 may be performed by one or more other computing devices.

As shown in FIG. 1, in operation 101, the implementation method 100 may monitor attribute information of a virtual digital object and user information in a scenario.

In an embodiment, the monitoring of the attribute information and the user information may be used for collecting the attribute information of an entity corresponding to the virtual digital object in the metaverse scenario and the user information in the scenario in real time, so that in subsequent operations, intelligent perception and decision-making of the virtual digital object may be performed based on the information, and active interaction with a user may be implemented according to perception results, whereby intelligent interaction with the user may be achieved, and the user may be enabled to obtain a surreal application experience in the metaverse without corresponding professional knowledge.

In an embodiment, the attribute information may include self-feature information of the virtual digital object and feature information of an environment where the virtual digital object is located. The feature information of the environment may include feature information of a micro-environment and/or a macro-environment. However, embodiments of the present disclosure are not limited to the above. Those skilled in the art may set an appropriate attribute information range according to interaction requirements with the virtual digital object in an actual application and/or based on design constraints.

Taking a plant as a non-limiting example, the self-feature information of the virtual digital object may include a plant species, a leaf size, a defoliation status, a plant height, a crown range, or the like. The feature information of the micro-environment may be and/or may include light, soil composition, pH value, water quality, temperature, humidity, wind power, direction, or the like, which may have been collected through various IoT devices, sensors, cameras, or the like. The feature information of the macro-environment may be and/or may include plants, weather, climate, geological, meteorological, and hydrological data, or the like and may be obtained from the Internet and/or from preset information databases.

In an embodiment, the user information in the scenario may be obtained from system login information and/or sensor data, which may include user login information and/or user related information collected by sensors in the scenario, such as, but not limited to, the distance between the user and the virtual digital object, or the like.

In an embodiment, the following operations may be used to monitor the attribute information of the virtual digital object.

Operation a1—Recognize a type of an entity corresponding to the virtual digital object.

In an embodiment, the type information of the entity corresponding to the virtual digital object may be obtained through computer vision, a user input, and/or a trained object recognition model. For example, the recognition method may be implemented by using a related and/or well-known technology. Consequently, a description of the recognition method may be omitted for the sake of brevity.

Operation a2—Obtain a corresponding set of object attributes based on the type. In an embodiment, the type of the entity corresponding to the virtual digital object may be input into a knowledge base and/or a rule base to obtain the set of object attributes that may be needed for object state inference.

Operation a3—Obtain corresponding attribute values for the virtual digital object based on the attributes indicated by the set of object attributes, so as to obtain the attribute information of the virtual digital object.

For example, the operation may be used for determining, for each attribute in the set of object attributes, a corresponding attribute value of the virtual digital object at the attribute.

In an embodiment, the attribute information of the virtual digital object may be obtained through computer vision, an IoT sensor, the Internet, a server, or the like. For example, the computer vision may be used to generate self-feature information of the virtual digital object. As another example, the IoT sensor may be used to generate feature information of the micro-environment. As another example, the Internet and/or a server may be used to generate feature information of the macro-environment. However, embodiments of the present disclosure are not limited to the foregoing examples. That is, in a practical application, a suitable method may be selected based on an actual requirement to obtain the attribute information of the virtual digital object.

Continuing to refer to FIG. 1, in operation 102, the implementation method 100 may generate state decision data of the virtual digital object and determine a current scenario type based on the attribute information. In addition, the implementation method 100 may determine a role type of each user in the scenario based on the user information. The state decision data may include state data, requirements, and/or suggestion information.

As used herein, requirements may refer to the conditions and/or specifications that may be needed for a virtual object to perform certain functions and/or to achieve one or more specified goals. For example, the requirements may include essential, functional, operational, and/or performance-related elements that may need to be met to satisfy the demands from the system and/or users.

In an embodiment, suggestion information may be designed or configured to assist users in making decisions and/or to enhance the user experience by providing recommendations and/or advice. For example, the suggestion information may suggest optimal actions and/or choices based on the user's current situation, preferences, and/or past activities, which may provide users with a relatively more effective and/or satisfying experience, when compared to related apparatuses.

In an embodiment, operation 102 may be used for performing state recognition, prediction, and/or user operation decision on the virtual digital object, and recognizing the current scenario type and the role type of each user, so as to implement subsequent intelligent interaction between the virtual digital object and the user based on the information obtained in the operation.

In an embodiment, the state data may include current state data and/or future state data. However, embodiments of the present disclosure are not limited in this regard. For example, those skilled in the art may determine a type of the state data to be generated according to an actual requirement.

In an embodiment, the current state data and the future state data may be generated by using at least one of the following two (2) methods.

Method 1—The current state data of the virtual digital object may be generated based on the attribute information in a state inferring manner by using a preset knowledge base or rule base. For example, for a plant type virtual digital object, environmental attribute condition values needed by the virtual digital object may be first obtained according to the set of object attributes through the knowledge base (KB) and/or rule base. Subsequently, the input attribute values of the virtual digital object may be compared with the environmental attribute condition values that may be needed by the virtual digital object. The current state of the object may be inferred through the KB and/or the rules.

Alternatively or additionally, the current state data of the virtual digital object may be generated based on the attribute information by using a pre-trained state inference model. For example, the state inference model may be built and trained by using a related machine learning method.

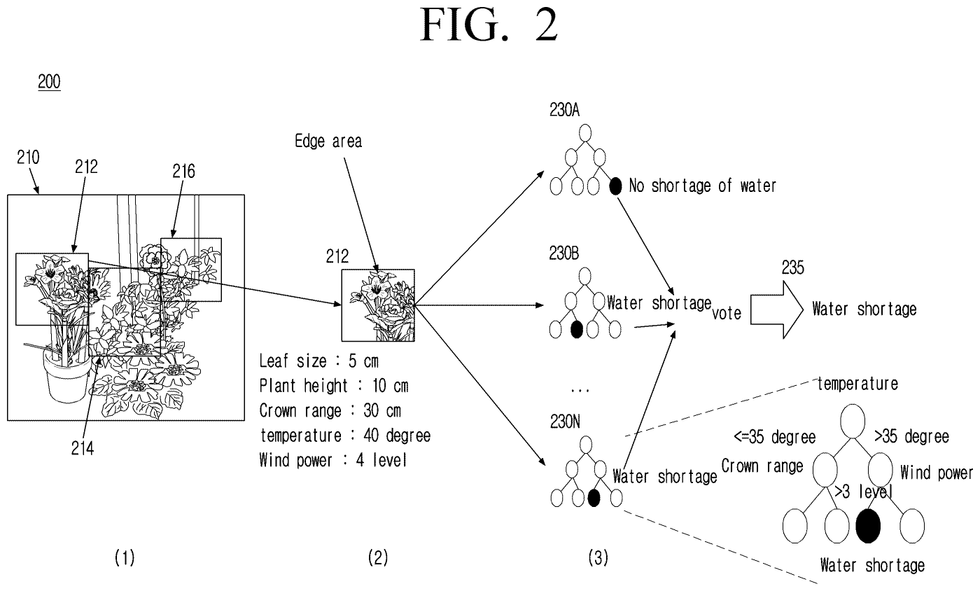

FIG. 2 is an example diagram of current state inference, according to an embodiment of the present disclosure. Referring to FIG. 2, a process flow 200 for performing current state inference by an apparatus (e.g., apparatus 1400 of FIG. 14) that implements one or more aspects of the disclosure is illustrated.

For example, as shown in FIG. 2, a random forest state inferring method may be used on a plant type virtual digital object 210 to learn (predict) whether the plant type virtual digital object is currently in a water shortage state.

In an embodiment, the process flow 200 may include recognize a type of the entity corresponding to the virtual digital object 210. For example, in the scenario depicted in (1) of FIG. 2, the entity type may be recognized as a plant type. In an embodiment, the type information of the entity corresponding to the virtual digital object may be obtained through computer vision in which one or more portions (e.g., a first portion 212, a second portion 214, and a third portion 216) of the plant type virtual digital object 210 may be examined. However, embodiments of the present disclosure are not limited in this regard, and other techniques such as, but not limited to, a user input and/or a trained object recognition model, may be used. In addition, two or more techniques may be used in combination to obtain the type information of the entity corresponding to the virtual digital object 210.

As shown in (2) of FIG. 2, at least one portion of the plant type virtual digital object 210 (e.g., the first portion 212) may be used to obtain a corresponding set of object attributes for the plant type virtual digital object 210 based on the type. For example, as further shown in (2) of FIG. 2, the process flow 200 may obtain a leaf size (e.g., 5 centimeters (cm)), a plant height (e.g., 10 cm), a crown range (e.g., 30 cm), a temperature (e.g., 40 degrees Celsius (° C.)), an indication of a wind power (e.g., level four (4)), or the like.

As shown in (3) of FIG. 2, the corresponding set of object attributes may be provided to a plurality of models (e.g., a first model 230A, a second model 230B, to an N-th model 230N, where N is a positive integer greater than one (1)). In an embodiment, the plurality of models 230A to 230N may be and/or may include a preset KB, a preset rule base, a pre-trained state inference model, or the like. Each model of the plurality of models 230A to 230N may be configured to estimate (predict) a current state data of the plant type virtual digital object 210 based on the corresponding set of object attributes. For example, the first model 230A may estimate that the current state data of the plant type virtual digital object 210 corresponds to a “No shortage of water” state, the second model 230B may estimate that the current state data of the plant type virtual digital object 210 corresponds to a “Water shortage” state, and the N-th model 230N may estimate that the current state data of the plant type virtual digital object 210 corresponds to the “Water shortage” state. In particular, the N-th model 230N may estimate the “Water shortage” state for the plant type virtual digital object 210 based on the temperature (e.g., 40° C.) being above a predetermined temperature threshold (e.g., 35° C.) and the wind power level (e.g., level four (4)) being above a predetermined wind power threshold (e.g., level three (3)). However, embodiments of the present disclosure are not limited in this regard, and the plurality of models 230A to 230N may be configured to output different and/or additional current state data based on substantially similar and/or different attribute information.

As further shown in (3) of FIG. 2, the process flow 200 may determine the current state data of the plant type virtual digital object 210 based on a combination of the individual outputs of each model of the plurality of models 230A to 230N. For example, a voting operation 235 may be performed to determine the current state data of the plant type virtual digital object 210 (e.g., “Water shortage”). However, embodiments of the present disclosure are not limited in this regard, and the outputs of each model of the plurality of models 230A to 230N may be combined in various manner without departing from the scope of the present disclosure. For example, in an embodiment, one or more priorities and/or weights may be applied to one or more models of the plurality of models 230A to 230N. As another example, one or more models of the plurality of models 230A to 230N may be ignored or omitted based on one or more of the corresponding set of attributes and/or the type information.

Although FIG. 2 illustrates an example based on the plant type virtual digital object 210, embodiments of the present disclosure are not limited thereto. That is, the principles described herein with reference to FIG. 2 may be applied to other types of virtual digital objects. For example, the aspects shown herein may be similarly applied to the current state data of an air conditioner that may be set as a virtual digital object in a smart home environment. In such an example, the virtual digital object may include attribute information such as, but not limited to, indoor temperature, humidity level, a cleanliness state of the air conditioner filter, an energy consumption amount, or the like. For example, the indoor temperature attribute may indicate the current temperature of the room in which the air conditioner is installed, the humidity level may represent a relative humidity measurement that may be used to identify whether the air conditioner needs to operate a drying and/or a humidifying function, the cleanliness state of the air conditioner filter may indicate a degree of dust accumulation of the filter and may be used to determine a time point when a filter cleaning and/or replacement may need to be notified, and the energy consumption amount may indicate an amount of power that may be currently consumed by the air conditioner. In an embodiment, an energy efficiency of the air conditioner may be evaluated, and conversion to the power saving mode may be suggested based on the power amount and the energy efficiency, or the like.

According to an embodiment, the current state data may be analyzed using a pre-trained state inference model, which may be used for optimizing the operation of the air conditioner, and may provide a suggestion constituting an appropriate environment to the user.

For example, in a case in which the indoor temperature is higher than the set temperature, and the energy consumption amount is not effective, the air conditioner may be set to operate in the power saving mode, and a notification recommending filter cleaning may be provided to the user. Alternatively or additionally, an interaction with the user may be determined by using the current state data, and a suggestion (advice) may be provided in real time through the virtual avatar.

Method 2—The future state data of the virtual digital object may be generated based on current attribute information and/or attribute information of the virtual digital object within a specified historical time period by using a pre-trained state prediction model.

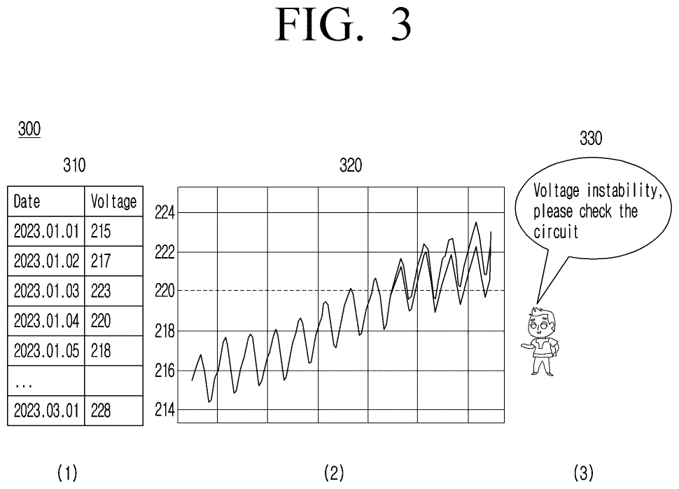

FIG. 3 is an example diagram of future state prediction, according to an embodiment of the present disclosure. Referring to FIG. 3, a process flow 300 for performing future state prediction by an apparatus (e.g., apparatus 1400 of FIG. 14) that implements one or more aspects of the disclosure is illustrated.

For example, as shown in FIG. 3, a future voltage of an electrical appliance may be predicted and a corresponding operation suggestion may be given based on a long-short term memory (LSTM) model.

According to an embodiment, the future state data of the refrigerator that may be set as a virtual digital object in a smart home environment may include attribute information such as, but not limited to, food stock, expiration date, prediction of energy consumption, a functional state, or the like.

The food stock attribute may indicate the types and/or quantities of food items that may be monitored inside the refrigerator. In an embodiment, a notification may be made to the user when a particular food item may be expected to be depleted soon (e.g., within a certain threshold).

The expiration date attribute may include information on the expiration dates of the food stock inside the refrigerator. In an embodiment, a notification may be made to the user in a case where the expiration date of a food item may arrive soon (e.g., within a certain threshold), and accordingly, waste of food may be reduced and/or prevented.

The prediction of energy consumption attribute may represent an amount of future energy consumption that may be predicted by analyzing data such as the use pattern of the refrigerator and the outer temperature, or the like. In an embodiment, an optimal energy saving mode may be recommended based on the prediction of energy consumption.

The functional state attribute may indicate a probability that cooling efficiency may be reduced. In an embodiment, maintenance may be recommended in advance of a possible failure, and/or a notification may be made to the user so that the user may take a necessary measure.

According to an embodiment, the future state data may be obtained by analyzing the use data and the pattern during a relatively long (predetermined) period, and may be used for effective use of the refrigerator and provide an improved user experience. For example, as shown in (1) of FIG. 3, a voltage 310 of the refrigerator may be monitored (e.g., from Jan. 1, 2023 to Mar. 1, 2023) and analyzed to generate a pattern 320 of the voltage of the refrigerator, as shown in (2) of FIG. 3. In an embodiment, a future voltage of the refrigerator may be predicted and determined to be outside of a desired voltage range. Consequently, a notification may be made to the user so that the user may take a necessary measure.

For example, an interaction 330 with the user may be determined by using the future state data, and a suggestion (advice) may be provided through the virtual avatar (e.g., “Voltage instability, please check the circuit”).

Returning to FIG. 1, in operation 102, the scenario type may be determined based on environmental feature information of the virtual digital object. For example, for the plant type virtual digital object 210 (as described with reference to FIG. 2), micro-environment attribute data may be input into a scenario recognition model to obtain the corresponding scenario type. In a practical application, the scenario type may alternatively be determined according to an application requirement and in combination with user information.

In addition, in operation 102, for the role type of each user in the scenario, different roles of users may be recognized in combination with different scenarios through a user management system (information user login) and/or computer vision technology.

In an embodiment, the role type of each user in the scenario may be recognized based on scenario images by using an existing user identity recognition method such as, but not limited to, a Practical Ultra Light Classification based scheme, or the like.

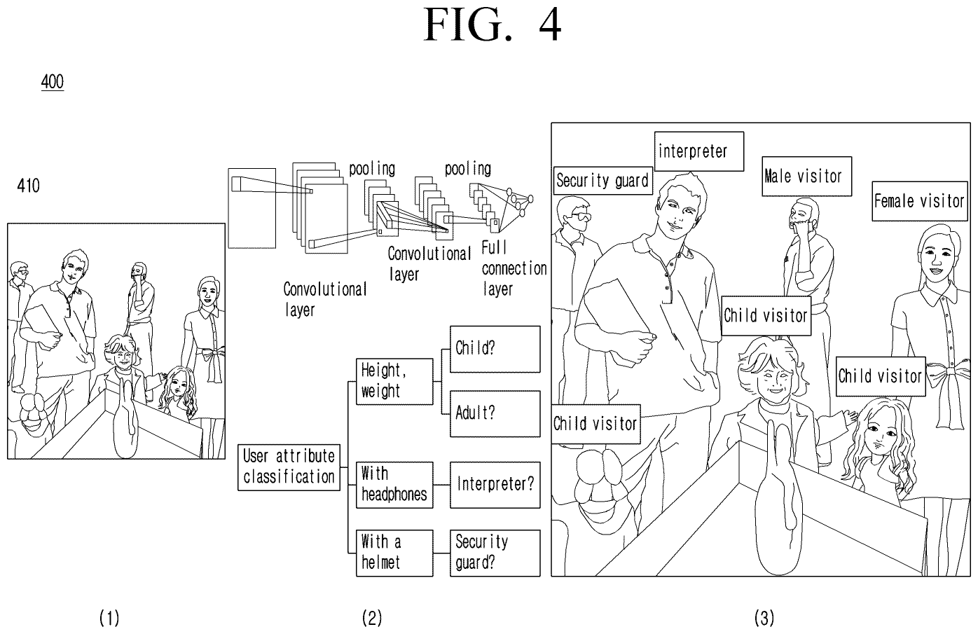

For example, as shown in FIG. 4, users in the scenario may be recognized (categorized) as at least one of a child visitor, a male visitor, a female visitor, an interpreter, a security guard, or the like, by using a user identity recognition method.

FIG. 4 is an example diagram of user identity recognition, according to an embodiment of the present disclosure. Referring to FIG. 4, a process flow 400 for performing user identity recognition by an apparatus (e.g., apparatus 1400 of FIG. 14) that implements one or more aspects of the disclosure is illustrated.

For example, as shown in (1) of FIG. 4, a user identity recognition method may be used on a user type virtual digital object 410 to recognize one or more users included in the user type virtual digital object 410.

As shown in (2) of FIG. 4, a corresponding set of object attributes for the user type virtual digital object 410 may be obtained. For example, the process flow 400 may obtain a height and weight attribute that may be used to determine whether the user is a child or an adult, a headphones attribute indicating whether the user is wearing headphones which may be used to determine whether the user is an interpreter, and a helmet attribute indicating whether the user is wearing a helmet which may be used to determine whether the user is a security guard. In an embodiment, the obtained attributes may be provided to a user identity recognition model that may include a plurality of convolutional layers and at least one full connection layer and configured to perform a pooling operation on the user type virtual digital object 410 and/or the obtained attributes to recognize (categorize) each user included in the user type virtual digital object 410 as at least one of a child visitor, a male visitor, a female visitor, an interpreter, or a security guard, as shown in (3) of FIG. 4.

Returning to FIG. 1, in operation 103, the implementation method 100 may determine, based on the state decision data and the user information, whether interaction with a user currently needs to be triggered, and if so, interact with the corresponding user in a virtual avatar manner by using a preset virtual avatar generator and a user dialog system based on the state decision data, the role type, and the scenario type, to notify the corresponding user of the state decision data of the virtual digital object, where stylization data of the virtual avatar are generated based on the state decision data and the role type.

In an embodiment, in order to implement an intelligent interaction with the user, time of the interaction with the user may need to be intelligently recognized, and the interaction with the corresponding user may need to be performed in the virtual avatar manner, so that the user may obtain a surreal application experience when interacting with a virtual digital object.

That is, by determining, based on the state decision data and the user information, whether interaction with a user currently needs to be triggered, the user may learn about a real-time and/or abnormal state of the virtual digital object in a timely manner through active interaction between the virtual digital object and the user, thereby enabling the user to meet various operation requirements of the entity corresponding to the virtual digital object in a timely manner. Moreover, through the interaction with the corresponding user in the virtual avatar manner, anthropomorphic interaction with the user may be implemented by using a three-dimensional (3D) virtual role of the virtual digital object, so that the user may obtain a surreal application experience in the interaction process. In addition, stylization data of the virtual avatar may be generated by combining the state decision data of the virtual digital object and the role type of the user. Thereby, the virtual avatar generated for the user may match the role type of the user, and accordingly, for the same virtual digital object, different user roles may also have different visual virtual images, so as to meet different communication requirements of different role types of users.

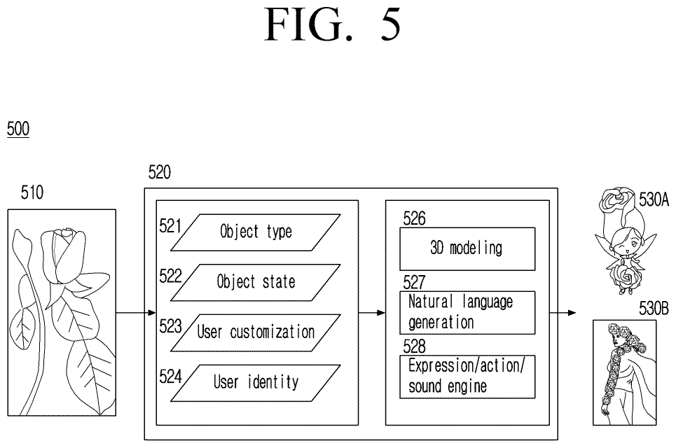

FIG. 5 shows an example 500 of generating different virtual avatars for different users with regard to a plant in a scenario. As shown in FIG. 5, for a rose virtual digital object 510, different virtual avatars (e.g., a first virtual avatar 530A and a second virtual avatar 530B) may be generated for different users. For example, a virtual avatar generator 520 may obtain a set of attributes from the rose virtual digital object 510 such as, but not limited to, an object type 521, an object state 522, a user customization 523, and a user identity 524. The virtual avatar generator 520 may apply at least one of 3D modeling 526, natural language generation 527, or an expression/action/sound engine 528 to generate at least one of the first or second virtual avatars 530A or 530B based on the set of attributes 521 to 524.

In an embodiment, the stylization data of the virtual avatar may include expression, posture, emotion, sound, or the like.

According to an embodiment, the stylization data may include visual and auditory style information that may be used when the virtual avatar interacts with the user. For example, the stylization data may define the outer appearance, the pose, the emotional expression, the voice, or the like of the virtual avatar, and may be customized according to the role type of the user, the state determination data, and the scenario type.

The stylization data of the virtual avatar may be adjusted as follows.

Expression and pose: The virtual avatar may take an expression and a pose that may fit a specific situation and/or the emotional state of the user. For example, when the user is experiencing sadness, the virtual avatar may use a consoling expression and/or a consoling pose.

Emotional expression: The virtual avatar may express various emotions such as, but not limited to, pleasure, sadness, amazement, or the like, which may increase a connection with the user and may promote a natural interaction with the user.

Voice and sound effects: The voice of the virtual avatar may be adjusted to fit a conversation with the user, and sound effects appropriate for each situation may be used, thereby potentially providing a more realistic and attractive interaction with the user.

The stylization data may play an important role in personalizing an interaction with the user, and enhancing the user's experience in the virtual environment. As the style of the virtual avatar may be adjusted according to the situation of the user, the user may experience a more realistic and satisfying interaction in the virtual environment.

In an embodiment, in order to enhance the intelligence of interaction between the virtual digital object and the user, whether the interaction with the user currently needs to be triggered may be determined by using at least one of the following methods.

If the state data indicates that the virtual digital object is in an abnormal state, it may be determined that the interaction with the user currently needs to be triggered.

If the distance between the user and the entity corresponding to the virtual digital object is within a preset range, it may be determined that the interaction with the user currently needs to be triggered.

In the foregoing method, when the user approaches the entity corresponding to the virtual digital object, an interaction mode may be triggered, and the virtual avatar may chat with the corresponding user. In addition, when the virtual digital object is in an abnormal state, an interaction mode may also be triggered, and the virtual avatar may notify the corresponding user of its state, requirements, and/or suggestions.

In a practical application, when a plurality of users are detected to be close (e.g., within a predetermined threshold) to the virtual digital object, a user who may directly face the corresponding entity may be selected as a current interaction object. However, embodiments of the present disclosure are not limited in this regard. For example, the current interaction user may alternatively be determined according to the requirements of an actual application scenario and a preset user selection strategy.

When the virtual digital object is detected to be in an abnormal state, the current interaction user may be determined according to a preset abnormality notification strategy. For example, an administrator may be designated as the current interaction user.

In an embodiment, in order to further use the virtual avatar that matches the user role and the scenario to interact with the user for improving the interaction experience, the interaction with the corresponding user may be implemented in a virtual avatar manner by performing at least one of the following three (3) operations.

Operation b1—Generate a virtual avatar for the virtual digital object by using the virtual avatar generator based on the type of the entity corresponding to the virtual digital object, the state decision data, the role type, the scenario type, and/or preset virtual avatar style configuration data.

In an embodiment, a degree of matching between the virtual avatar and the user role may be improved by considering the type of the entity corresponding to the virtual digital object, the state decision data, the role type, the scenario type, and/or the preset virtual avatar style configuration data. For example, input information for generating the virtual avatar may be set by those skilled in the art according to actual application requirements.

The virtual avatar style configuration data may be and/or may include stylization data customized by the user for the virtual digital object and/or default virtual avatar stylization data preset by a system.

In an embodiment, the virtual avatar generator may be built and trained by using existing methods. Consequently, further description of the virtual avatar generator may be omitted for the sake of brevity.

Operation b2—Generate, for the virtual avatar, a dialog sentence for current interaction with the user by using the user dialog system based on the state decision data, the role type, and the scenario type, and output the dialog sentence by using the virtual avatar.

In an embodiment, interactive content information may be generated based on not only the state decision data but also the role type of the user and the scenario type, so that the topic of interaction with the user may match the role type of the user and the scenario type, whereby interaction requirements between different users and the virtual digital object may be met, personification of the interaction form and intelligence of the interactive content may be enhanced, the interaction process between the virtual digital object and the user further has naturalness of interaction between persons, and the user may obtain a surreal interactive experience.

For example, when the scenario information is about a family and a holiday (e.g., Children's Day), and the user roles are guests and children, the virtual avatar of a refrigerator may output a dialog sentence “Happy Children's Day, this is ice cream for you” in a child's tone. As another example, when the scenario information is about a family and a weekend, and the user role is a host, the virtual avatar of the refrigerator may output a dialog sentence “Fruit juice is not enough, it's better to go to the supermarket to purchase some more” in an adult's tone.

The user dialog system may be used for natural language understanding, automatic speech recognition, text speech synthesis, or the like. In an embodiment, an existing intelligent speech dialog system may be used. Consequently, further description of the intelligent speech dialog system may be omitted for the sake of brevity.

Operation b3—When the user's dialog sentence is detected, update the stylization data of the virtual avatar by using the virtual avatar generator based on current dialog context, the state decision data, the role type, and the scenario type, and generate a matching reply sentence for the virtual avatar by using the dialog system.

In an embodiment, the virtual avatar generator may update the stylization data of the virtual avatar by combining the dialog context (which may include the user's current reply sentence), the scenario, the user role, the state decision data of the virtual digital object, or the like so that the performance style of the virtual avatar may be closely related to the interaction content of the current dialog. That is, the expression, emotion, and sound effects, or the like of the virtual avatar in the interaction process may be changed according to the state and requirements of the corresponding entity in the real world and user feedback, thereby potentially improving the intelligence of interaction between the virtual avatar and the user, which may meet the requirements of interaction between the user and the corresponding entity in the real world.

In a practical application, the virtual avatar may put forward a request and/or suggestion to the user nearby or remotely, and correspondingly, the user may feed a dialog sentence back nearby by using an augmented reality device (such as, for example, virtual reality (VR) glasses) and/or feed a dialog sentence back through a mobile terminal remotely.

According to aspects of the present disclosure, it may be seen that in the implementation scheme of implementing enhanced virtual digital representation in metaverse, attributes of a virtual digital object and user information in a scenario may be collected in real time, and a state of the virtual digital object may be analyzed and/or determined based on the collected information, to implement an automatic perception on the virtual digital object and intelligent decision-making on its operation, thereby potentially enhancing the intelligence of an interaction between the virtual digital object and a user, and/or potentially reducing professional knowledge requirements for the user during interaction with the virtual digital object. In addition, the time of interaction with the user may be autonomously recognized based on the collected information and the analysis results, and when interaction is determined to be needed, the interaction with the corresponding user may be implemented in a virtual avatar manner based on the state decision data, the role type, and the scenario type, so that the manner and content of the interaction with the user may be customized to the user and the scenario type. That is, stylization data of an anthropomorphic avatar (e.g., a virtual avatar) may be generated based on the state decision data and the role type, so that the display style of the virtual avatar may match the user role, and the user may obtain a surreal application experience.

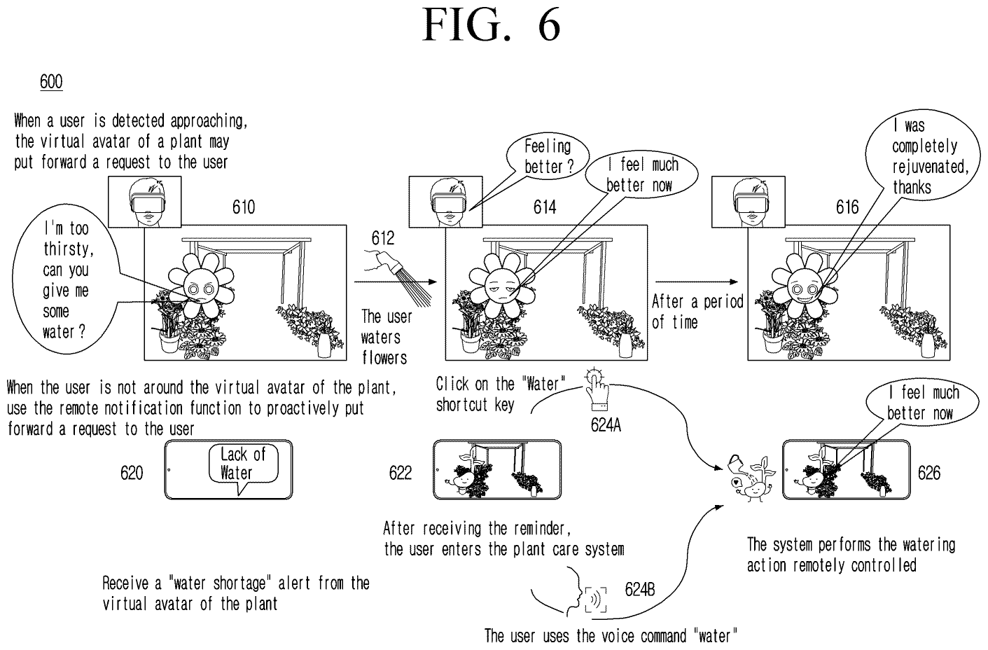

FIGS. 6 to 13 are example diagrams of applications in specific scenarios, according to embodiments of the present disclosure.

Referring to FIG. 6, a first plant care scenario 600 is illustrated. The first plant care scenario 600 may be performed by an apparatus (e.g., apparatus 1400 of FIG. 14) that implements one or more aspects of the disclosure.

As shown in FIG. 6, the expression, emotion, and sound effects of a virtual avatar of a plant may vary based on the state of the plant and the environment. For example, the virtual avatar of the plant may put forward a request to a user nearby or remotely, and user's feedback may also be implemented nearby or remotely; and the virtual avatar of the plant may change vividly based on its state through expression, sound effects, or the like.

In operation 610, when a user is detected approaching a plant type virtual digital object and the current state of the plant type virtual digital object is detected to be in an abnormal state, the plant type virtual digital object may notify the user of the abnormal state according to a preset abnormality notification strategy. In an embodiment, a virtual avatar of the plant type virtual digital object may put forward (present) a request to the user. For example, the virtual avatar may display a message that may state “I'm thirsty, can you give me some water?”.

In response, the user may, in operation 612, manually provide water to the physical plant (e.g., flowers) represented by the plant type virtual digital object.

In operation 614, an appearance and/or style of the virtual avatar of the plant type virtual digital object may be changed based on changes to the current state of the plant type virtual digital object due to the user watering the plant. For example, the virtual avatar of the plant type virtual digital object may respond “I feel much better now” to the user in response to a status request query (e.g., “Feeling better?”). Alternatively or additionally, in operation 616, after a period of time has elapsed, the appearance, style, and/or expression of the virtual avatar of the plant type virtual digital object may be further changed may on further changes to the current state of the plant type virtual digital object. That is, after the passing of the period of time, the current state of the plant type virtual digital object may no longer be in an abnormal state, and the appearance, style, and/or expression of the virtual avatar of the plant type virtual digital object may reflect and/or correspond to the new state of the plant type virtual digital object, as shown in operation 616. For example, the operation 616 may include the virtual avatar of the plant type virtual digital object notifying the user that the current state is no longer an abnormal state (e.g., “I was completely rejuvenated, thanks”).

Alternatively or additionally to operations 610 to 616, when the user is not within a near proximity (within a certain distance threshold) and/or around the plant type virtual digital object and the current state of the plant type virtual digital object is detected to be in an abnormal state, the plant type virtual digital object may, in operation 620, send a remote notification to the user to proactively put forward (present) a request to the user. For example, the user may receive a water shortage notification (alert) from the virtual avatar.

In response to receiving the notification, the user may enter a plant care system which the user may command to provide water to the physical plant (e.g., flowers) represented by the plant type virtual digital object, similarly to operation 612. For example, the user may, in operation 624A, click on a Water shortcut key (or button) provided by the plant care system or the user may, in operation 625 issue a voice command of “water” to instruct the plant care system to automatically provide water to the physical plant.

In operation 626, the plant care system may remotely perform the watering requested by the user and may remotely notify the user when the abnormal state of the plant type virtual digital object has been overcome. For example, the virtual avatar may notify that “I feel much better now”.

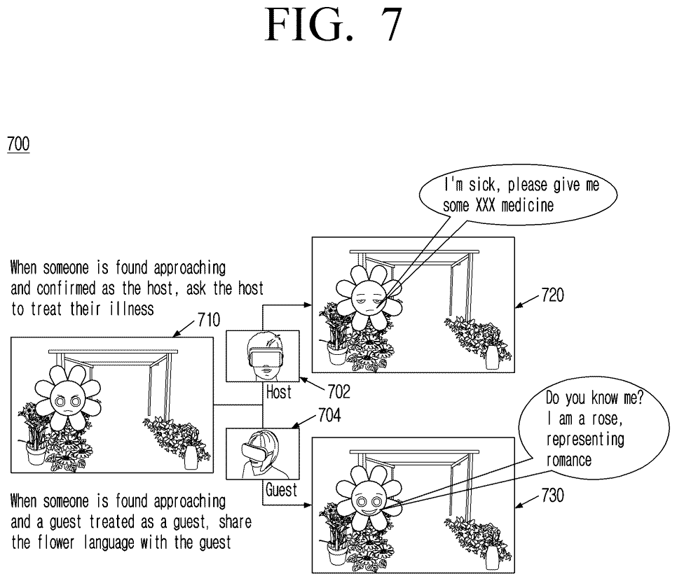

Referring to FIG. 7, a second plant care scenario 700 is illustrated. The second plant care scenario 700 may be performed by an apparatus (e.g., apparatus 1400 of FIG. 14) that implements one or more aspects of the disclosure.

As shown in FIG. 7, the virtual avatar of the plant type virtual digital object may communicate with users on different topics based on different user roles. The virtual avatar of the plant type virtual digital object may communicate with its host (owner) 702 on daily maintenance topics, such as, but not limited to disease treatment topics, and the virtual avatar of the plant type virtual digital object may communicate with guests 704 on entertainment topics, such as, but not limited to, flower language topics.

In operation 710, when the host 702 is detected approaching a plant type virtual digital object and the current state of the plant type virtual digital object indicates that the plant has an illness, the plant type virtual digital object may notify the host 702 of the illness according to a preset abnormality notification strategy. For example, in operation 720, the virtual avatar may display a message to the host 702 that may state “I'm sick, please give me some XXX medicine”.

Alternatively, in operation 710, when a guest 704 is detected approaching a plant type virtual digital object, the plant type virtual digital object may share flower language topics with the guest 704. For example, in operation 730, the virtual avatar may display a message to the guest 704 that may state “Do you know me? I am a rose, representing romance”.

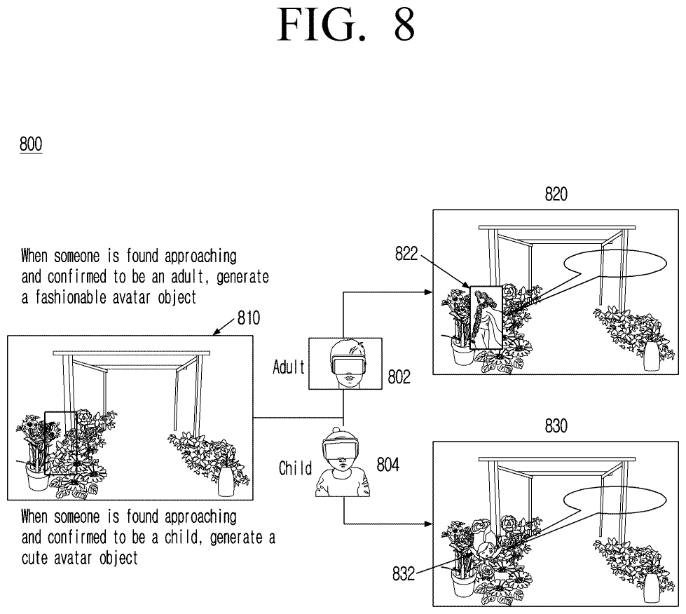

Referring to FIG. 8, a third plant care scenario 800 is illustrated. The third plant care scenario 800 may be performed by an apparatus (e.g., apparatus 1400 of FIG. 14) that implements one or more aspects of the disclosure.

As shown in FIG. 8, for the same virtual digital object, different styles of avatars may be automatically generated based on different user roles. For example, a cute style avatar may be generated for a child user 804, and/or a fashionable style avatar may be generated for an adult user 802.

In operation 810, when the adult user 802 is detected approaching a plant type virtual digital object, the plant type virtual digital object may generate a fashionable avatar 822, as shown in operation 820. Alternatively, when a child user 804 is detected approaching the plant type virtual digital object, the plant type virtual digital object may generate a cute style avatar 832, as shown in operation 830.

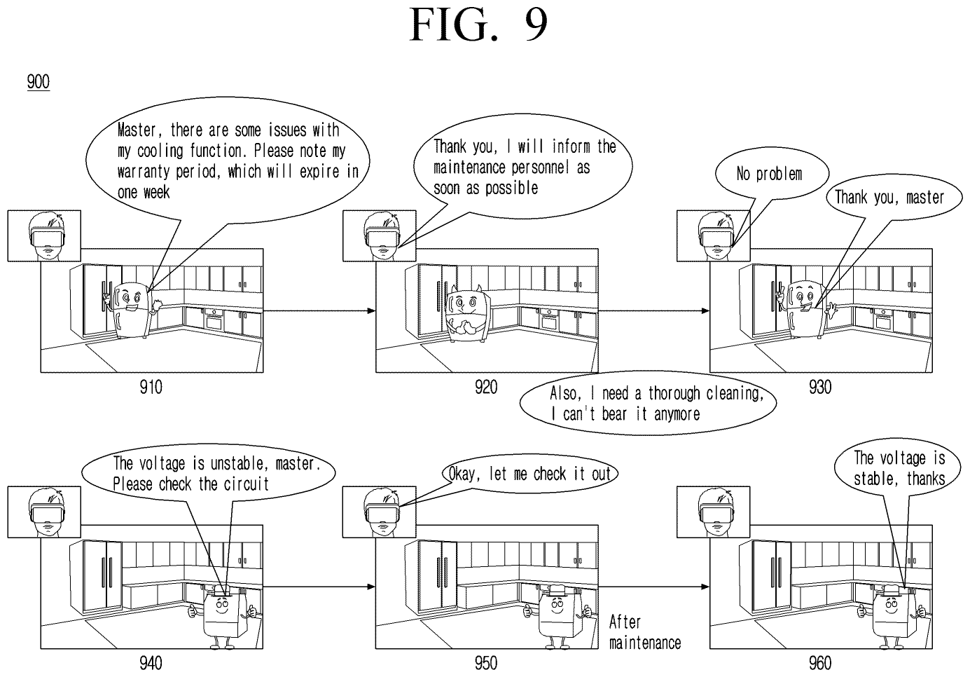

Referring to FIG. 9, a first appliance scenario 900 is illustrated. The first appliance scenario 900 may be performed by an apparatus (e.g., apparatus 1400 of FIG. 14) that implements one or more aspects of the disclosure.

As shown in FIG. 9, a virtual avatar of an appliance type virtual digital object may actively report its state to a user, and may also actively remind its owner of some prompts, such as, but not limited to, an expiration date of a warranty period.

In operation 910, the virtual avatar of the appliance type virtual digital object may notify the user that the expiration date of the warranty period is relatively soon (e.g., within a predetermined threshold). For example, the virtual avatar may display a message to the user that may state “Master, there are some issues with my cooling function. Please note my warranty period, which will expire in one week”. In response, the user may indicate to the virtual avatar that the maintenance issue is being addressed. For example, the user may provide to the virtual avatar a message that may state “Thank you, I will inform the maintenance personnel as soon as possible”, as shown in operation 920.

In an embodiment, the virtual avatar may notify the user that the appliance needs a cleaning. For example, as shown in operation 920, the virtual avatar may display a message to the user that may state “Also, I need a thorough cleaning, I can't bear it anymore”. In operation 930, the user may respond to the cleaning notification by stating “No problem”, and the virtual avatar may acknowledge the user's response by displaying a message to the user that may state “Thank you, master”.

In operation 940, the virtual avatar of another appliance type virtual digital object may notify the user that a future value of an attribute may be predicted to be outside of a desired range. That is, a notification may be made to the user so that the user may take a necessary measure. For example, it may be determined that a future voltage of the appliance may be outside of a desired voltage range and the appliance type virtual digital object may notify the user by displaying a message to the user that may state “The voltage is unstable, master. Please check the circuit.” In operation 950, the user may acknowledge the notification by responding to the virtual avatar with a message that may state “Okay, let me check it out” Subsequently, after maintenance has been performed on the circuit and the voltage instability has been resolved, the virtual avatar may notify the user that the previous issue has been resolved by displaying to the user a message that may state “The voltage is stable, thanks”, as shown in operation 960.

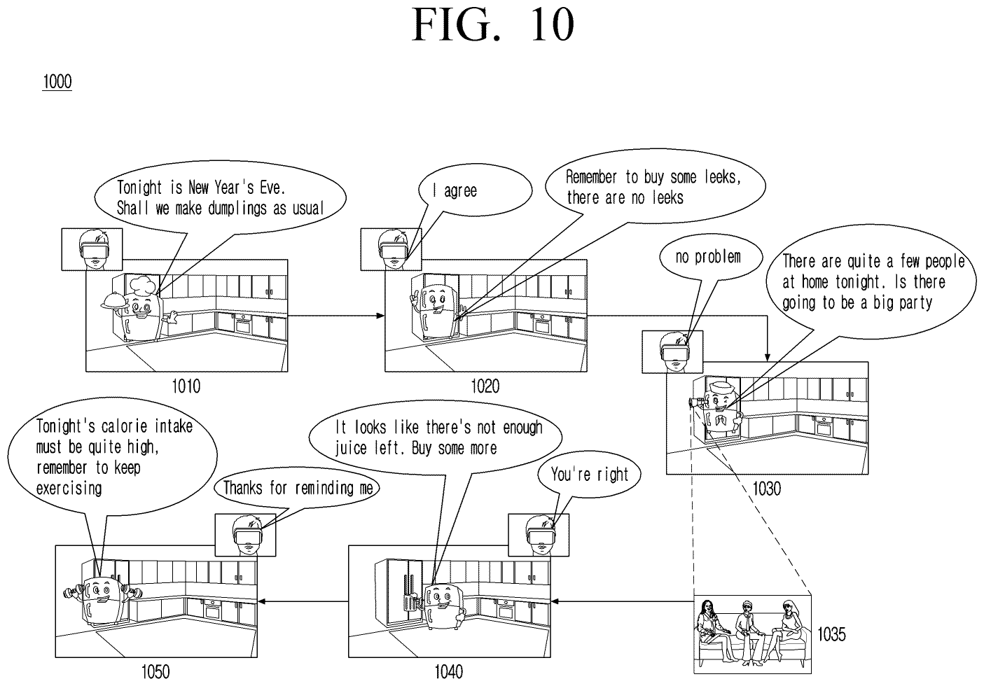

Referring to FIG. 10, a second appliance scenario 1000 is illustrated. The second appliance scenario 1000 may be performed by an apparatus (e.g., apparatus 1400 of FIG. 14) that implements one or more aspects of the disclosure.

As shown in FIG. 10, in this scenario, the virtual avatar of the appliance may recognize different scenarios and provide corresponding recommendations. For example, the virtual avatar of the appliance may recommend a recipe to be prepared, in operation 1010, according to traditional recipes that may be prepared for a particular holiday (e.g., leek dumplings in New Year's Eve) and or recipes that may have been prepared in previous occurrences of the holiday. In addition, the virtual avatar of the appliance may determine, in operation 1020, whether there are sufficient ingredients to prepare the recommended recipe and notify the user if any additional ingredients need to be obtained or purchased (e.g., “Remember to buy some leeks, there are no leeks.”).

In operation 1030, the virtual avatar of the appliance may detect a number of people in the home environment. For example, the virtual avatar may notify the user that a large number of people have been detected (e.g., above a certain threshold) and request information as to the purpose of the people in attendance (e.g., “There are quite a few people at home tonight. Is there going to be a party”). In an embodiment, the virtual avatar may also display to the user an image 1035 with the people in attendance.

The virtual avatar of the appliance may also remind of the lack of food based on the detected family size and provide an exercise advice based on calorie intake. For example, in operation 1040, the virtual avatar may determine whether there is enough food or drink for the detected number of people, and may notify the user if a particular food needs to be replenished (e.g., “It looks like there's not enough juice left. Buy some more”). As another example, in operation 1050, the virtual avatar may notify the user whether the calorie daily intake of the user is high (e.g., above a predetermined threshold) and provide recommendations (e.g., “Tonight's calorie intake must be quite high, remember to keep exercising”).

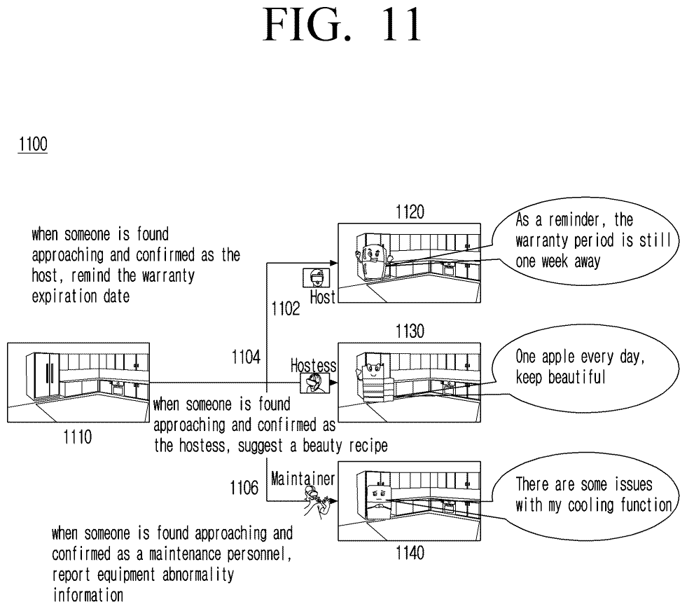

Referring to FIG. 11, a third appliance scenario 1100 is illustrated. The third appliance scenario 1100 may be performed by an apparatus (e.g., apparatus 1400 of FIG. 14) that implements one or more aspects of the disclosure.

As shown in FIG. 11, the virtual avatar of the appliance may communicate with users of different topics based on different user roles. In an embodiment, in operation 1110, a user may be detected as approaching the appliance and may be categorized as at least one of a host 1102, a hostess 1104, a maintainer 1106, or a guest. In addition, the virtual avatar may interact differently with the detected user based on the category of the user. For example, in operation 1120, the virtual avatar of the appliance may communicate with the male host 1102 on an expiration date of a warranty period of the appliance (e.g., “As a reminder, the warranty period is still one week away”). As another example, in operation 1130, the virtual avatar of the appliance may communicate with the hostess 1104 on beauty recipe topics (e.g., “One apple every day, keep beautiful”). As another example, the virtual avatar of the appliance may communicate with a guest on latest TV drama topics. As another example, in operation 1140, the virtual avatar of the appliance may communicate with the maintainer 1106 (maintenance person) on functional abnormalities (e.g., “There are some issues with my cooling function”). Alternatively or additionally, when more than one person is detected, the virtual avatar of the appliance may choose to communicate with the person directly facing the corresponding entity of the virtual avatar.

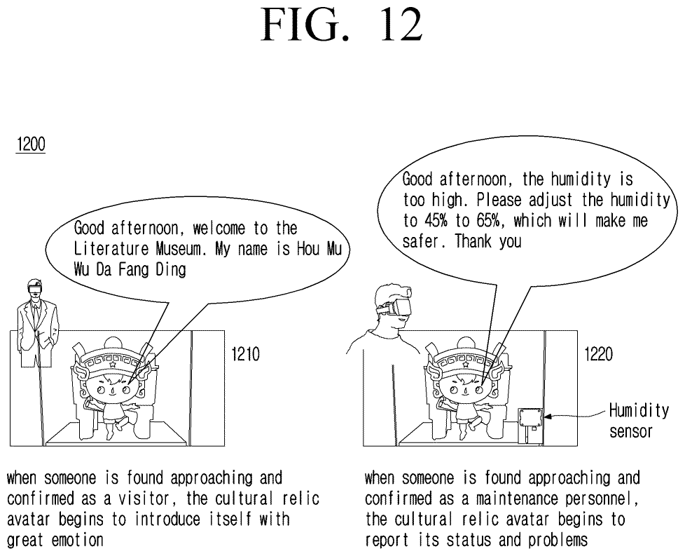

Referring to FIG. 12, a first cultural relic guide and maintenance scenario 1200 is illustrated. The first cultural relic guide and maintenance scenario 1200 may be performed by an apparatus (e.g., apparatus 1400 of FIG. 14) that implements one or more aspects of the disclosure.

As shown in FIG. 12, a virtual avatar of a cultural relic may recognize an approaching user and start an interaction with the user. In an embodiment, the virtual avatar of the cultural relic may also recognize persons of different roles and communicate accordingly. For example, when the virtual avatar of the cultural relic recognizes the user as a visitor, in operation 1210, the virtual avatar of the cultural relic may actively introduces itself to the visitor (e.g., “Good afternoon, welcome to the Literature Museum. My name is Hou Mu Wu Da Fang Ding”). Alternatively or additionally, in operation 1220, when the virtual avatar of the cultural relic recognizes the user as a maintenance person, the virtual avatar of the cultural relic may actively report its state to the maintenance person (e.g., “Good afternoon, the humidity is too high. Please adjust the humidity to 45% to 65%, which will make me safer. Thank you”).

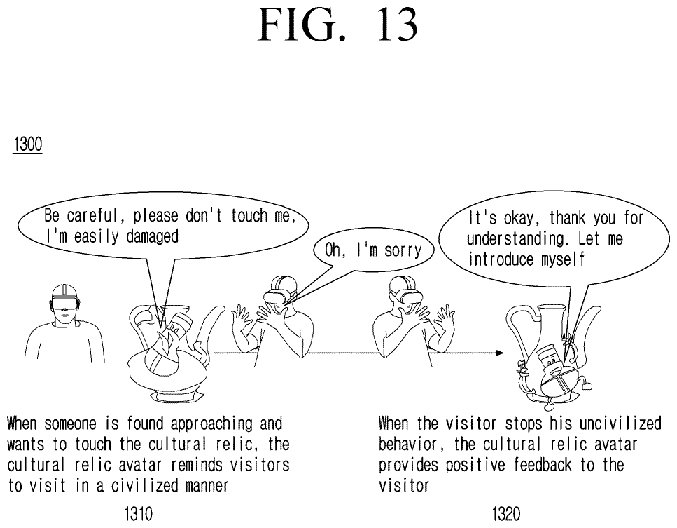

Referring to FIG. 13, a second cultural relic guide and maintenance scenario 1300 is illustrated. The second cultural relic guide and maintenance scenario 1300 may be performed by an apparatus (e.g., apparatus 1400 of FIG. 14) that implements one or more aspects of the disclosure.

As shown in FIG. 13, the virtual avatar of the cultural relic may recognize a person's uncivilized visiting behavior and actively discourage the behavior.

For example, in operation 1310, when a user is be detected, categorized as a visitor, and determined as approaching the cultural relic with an intent to touch the cultural relic, the virtual avatar of the cultural relic may remind the visitor to visit in a civilized manner (e.g., “Be careful, please don't touch me, I'm easily damaged”).

In operation 1320, when the visitor stops his uncivilized behavior, the cultural relic avatar may provide positive feedback to the visitor (e.g., “It's okay, thank you for understanding. Let me introduce myself”).

Although FIGS. 6 to 13 illustrate examples of possible scenarios according to various embodiments, the present disclosure is not limited to these examples. That is, the aspects presented herein with reference to FIGS. 1 to 13 may be applied to other types of virtual digital objects and/or other possible scenarios without departing from the scope of the present disclosure. Thus, the aspects presented herein may provide for implementing an enhanced virtual digital representation in a metaverse.

FIG. 14 is a schematic structural diagram of an implementation apparatus for implementing enhanced virtual digital representation in metaverse, according to an embodiment of the present disclosure.

Referring to FIG. 14, an implementation apparatus 1400 may include an information collection unit 1401, an information processing unit 1402, and an interaction unit 1403.

The information collection unit 1401 may be configured to monitor attribute information of a virtual digital object and user information in a scenario.

The information processing unit 1402 may be configured to generate state decision data of the virtual digital object and determine a current scenario type based on the attribute information, and determine a role type of each user in the scenario based on the user information. The state decision data may include state data, requirements, and/or suggestion information.

The interaction unit 1403 may be configured to determine, based on the state decision data and the user information, whether interaction with a user currently needs to be triggered, and if so, interact with the corresponding user in a virtual avatar manner by using a preset virtual avatar generator and a user dialog system based on the state decision data, the role type, and the scenario type, to notify the corresponding user of the state decision data of the virtual digital object. The stylization data of the virtual avatar may be generated based on the state decision data and the role type.

In an embodiment, each of the information collection unit 1401, the information processing unit 1402, and the interaction unit 1403 may be physically implemented by analog and/or digital circuits including one or more of a logic gate, an integrated circuit, a microprocessor, a microcontroller, a memory circuit, a passive electronic component, an active electronic component, an optical component, and the like. For example, a field programmable gate array (FPGA) may be used to implement custom logic that may include the functionality of at least one of the information collection unit 1401, the information processing unit 1402, or the interaction unit 1403. As another example, the implementation apparatus 1400 may include at least one processor, including processing circuitry, and memory storing instructions. The instructions, when executed by the one or more processors individually or collectively, may cause the implementation apparatus 1400 to perform the functionality of at least one of the information collection unit 1401, the information processing unit 1402, or the interaction unit 1403.

In an embodiment, the at least one processor may be implemented as at least one of a digital signal processor (DSP), a microprocessor, a time controller (TCON), or the like. However, embodiments of the present disclosure are not limited thereto, and the at least one processor may include one or more of a central processing unit (CPU), a micro controller unit (MCU), a micro processing unit (MPU), a controller, an application processor (AP), a communication processor (CP), an advanced reduced instruction set computing (RISC) machine (ARM) processor, an artificial intelligence (AI) processor, or the like. Alternatively or additionally, the at least one processor may be implemented as a system on chip (SoC) having a processing algorithm stored therein, as a large scale integration (LSI) chip, and/or in the form of an FPGA. The at least one processor may perform various functions by executing computer executable instructions stored in the memory.

It is to be understood that the implementation method 100 and implementation apparatus 1400 may be based on substantially similar aspects. Because the implementation method 100 and the implementation apparatus 1400 may address similar technical aspects based on similar principles, the implementations of the implementation method 100 and the implementation apparatus 1400 may be referred to each other. Consequently, repeated descriptions thereof may be omitted for the sake of brevity.

Based on the implementation method 100, an embodiment of the present disclosure further provides an implementation apparatus 1400 for implementing enhanced virtual digital representation in a metaverse, which includes at least one processor and memory. The memory may store an application program executable by the at least one processor that enables the at least one processor to perform the implementation method 100 for implementing enhanced virtual digital representation in a metaverse. That is, a system and/or an apparatus equipped with a storage medium may be provided, in which the storage medium stores software program code for realizing functions of any implementation in the foregoing embodiments, and a computer (CPU or MPU) of the system and/or apparatus may be enabled to read and/or execute the program code stored in the storage medium. In addition, an operating system or the like operated on the computer may be enabled through instructions based on the program code to complete some or all of actual operations. The program code read from the storage medium may further be written to a memory set in an expansion board inserted into the computer and/or written to a memory set in an expansion unit connected to the computer, and a CPU or the like installed on the expansion board or expansion unit may be enabled through instructions based on the program code to perform some or all of actual operations, thereby realizing functions of any of the forgoing embodiments of the implementation method 100 for implementing enhanced virtual digital representation in a metaverse.

The memory may be implemented as at least one of various storage media such as, but not limited to, an electrically erasable programmable read-only memory (EEPROM), a flash memory, a programmable read-only memory (PROM), or the like. The at least one processor may be implemented to include one or more CPUs and/or one or more FPGAs, where the FPGAs may integrate one or more CPU cores. That is, the CPU core may be implemented as a CPU and/or an MCU.

An embodiment of the present disclosure implements a computer program product, including a computer program/instructions, characterized in that the steps of the implementation method 100 for implementing enhanced virtual digital representation in a metaverse are implemented when the computer program/instructions are executed by at least one processor.

It is to be understood that not all operations and/or modules in the foregoing processes and structural diagrams may be necessary, and some operations and/or modules may be ignored (omitted) according to actual requirements. The execution sequence of each operations is not fixed, and thus, may be adjusted as needed. The division of each module is only a functional division for the convenience of description. In actual implementations, a module may be implemented by a plurality of modules, functions of a plurality of modules may also be implemented by the same module, and these modules may be located in the same device or different devices.

The hardware modules in each implementation may be implemented mechanically or electronically. For example, a hardware module may include a specially designed permanent circuit or logic device (e.g., a dedicated processor, such as, but not limited to, an FPGA and/or an application-specific integrated circuit (ASIC)) for completing specific operations. The hardware module may alternatively include a programmable logic device or circuit (such as, but not limited to, a general-purpose processor or other programmable processors) temporarily configured by software for performing specific operations. The implementation of the hardware module in a mechanical manner or using a dedicated permanent circuit or a temporarily configured circuit (e.g., configured by software) may be determined based on cost and time considerations.

As used herein, schematic may indicate an instance, example, and/or explanation. Any schematic diagram or implementation described herein should not be interpreted as a more preferred or advantageous technical scheme. For simplicity of the drawings, only the parts related to the present disclosure may be schematically shown in the drawings, which may not represent actual structures of products. In addition, in order to make the drawings simple and easy to understand, only one of the components having the same structure or function is schematically depicted or marked in some drawings. As used herein, the term “one” may not limit a quantity of related parts of the present disclosure to “only one”, and “one” may not exclude cases in which the quantity of related parts of the present disclosure may be more than one. Herein, “upper”, “lower”, “front”, “back”, “left”, “right”, “inside”, “outside”, or the like may only be used for representing relative positional relationships between related parts, rather than limiting the absolute positions of these related parts.

Personal information involved in the schemes described in this specification and the embodiments may be processed on a legal basis (e.g., obtaining the consent of a personal information subject, or that may be needed for fulfilling a contract) and only within a specified or agreed scope. Personal information refused by the user except the necessary information for basic functions may not affect the use of the basic functions.

In summary, the above embodiments of the present disclosure are not intended to limit the protection scope of the present disclosure. Any modification, equivalent replacement, improvement, or the like made within the spirit and principle of the present disclosure may fall within the protection scope of the present disclosure.

What is claimed is:

1. A method for implementing enhanced virtual digital representation in a metaverse, the method comprising:
monitoring attribute information of a virtual digital object and user information of at least one user in a scenario;
obtaining, based on the attribute information, state decision data of the virtual digital object;
determining, based on the state decision data and the user information, whether an interaction with a user in the scenario needs to be triggered; and
notifying, based on determining that the interaction with the user needs to be triggered, the user of the state decision data of the virtual digital object by interacting with the user using a virtual avatar.

2. The method of claim 1, further comprising:
identifying, based on the attribute information, a current scenario type; and
identifying, based on the user information, a role type of each user of the at least one user in the scenario.

3. The method of claim 2, wherein the state decision data comprises at least one of current state data, future state data, requirements, or suggestion information,
wherein the interacting with the user comprises generating, using a preset virtual avatar generator and a user dialog system, the virtual avatar based on the state decision data, the role type, and the current scenario type, and
wherein the method further comprises performing, using the user dialog system, at least one of natural language understanding, automatic speech recognition, or text speech synthesis.

4. The method of claim 2, wherein the interacting with the user comprises:
customizing at least one of an appearance, a pose, an emotional expression, or a voice of the virtual avatar, based on the state decision data, the role type, and the current scenario type.

5. The method of claim 1, wherein the attribute information comprises self-feature information of the virtual digital object and feature information of an environment where the virtual digital object is located, and
wherein the environment comprises at least one of a micro-environment or a macro-environment.

6. The method of claim 1, wherein the monitoring of the attribute information of the virtual digital object comprises:
identifying a type of an entity corresponding to the virtual digital object;
obtaining a corresponding set of object attributes based on the type of the entity; and
obtaining corresponding attribute values for the virtual digital object based on attributes indicated by the corresponding set of object attributes to obtain the attribute information of the virtual digital object.

7. The method of claim 3, further comprising:
obtaining the current state data of the virtual digital object based on the attribute information in a state inferring manner by using a preset knowledge base or rule base.

8. The method of claim 3, further comprising:
obtaining the current state data of the virtual digital object based on the attribute information by using a pre-trained state inference model.

9. The method of claim 3, further comprising:
obtaining, by using a pre-trained state prediction model, the future state data of the virtual digital object based on at least one of the attribute information of the virtual digital object or historical attribute information of the virtual digital object within a specified historical time period.

10. The method of claim 3, wherein the determining whether the interaction with the user in the scenario needs to be triggered comprises:
based on state data indicating that the virtual digital object is in an abnormal state, determining that the interaction with the user in the scenario needs to be triggered, the state data comprising the current state data and the future state data; and
based on a distance between the user and an entity corresponding to the virtual digital object being within a preset range, determining that the interaction with the user in the scenario needs to be triggered.

11. The method of claim 3, wherein the interacting with the user further comprises:
obtaining the virtual avatar for the virtual digital object by using the preset virtual avatar generator based on at least one of a type of an entity corresponding to the virtual digital object, the state decision data, the role type, the current scenario type, or preset virtual avatar style configuration data;
obtaining, for the virtual avatar, a first dialog sentence for the interaction with the user by using the user dialog system based on the state decision data, the role type, and the current scenario type, and outputting the first dialog sentence by using the virtual avatar; and
based on a second dialog sentence being detected from the user, updating the preset virtual avatar style configuration data of the virtual avatar by using the preset virtual avatar generator based on current dialog context, the state decision data, the role type, and the current scenario type, and obtaining a matching reply sentence for the virtual avatar by using the user dialog system.

12. An apparatus for implementing enhanced virtual digital representation in a metaverse, comprising:
one or more processors comprising processing circuitry; and
memory storing instructions,
wherein the instructions, when executed by the one or more processors individually or collectively, cause the apparatus to:
monitor attribute information of a virtual digital object and user information of at least one user in a scenario;
obtain, based on the attribute information, state decision data of the virtual digital object;
determine, based on the state decision data and the user information, whether an interaction with a user in the scenario needs to be triggered; and
notify, based on a determination that the interaction with the user needs to be triggered, the user of the state decision data of the virtual digital object by interacting with the user using a virtual avatar.

13. The apparatus of claim 12, wherein the instructions, when executed by the one or more processors individually or collectively, further cause the apparatus to:
identify, based on the attribute information, a current scenario type; and
identify, based on the user information, a role type of each user of the at least one user in the scenario.

14. The apparatus of claim 13, wherein the state decision data comprises at least one of current state data, future state data, requirements, or suggestion information,
wherein the instructions, when executed by the one or more processors individually or collectively, further cause the apparatus to:
generate, using a preset virtual avatar generator and a user dialog system, the virtual avatar based on the state decision data, the role type, and the current scenario type; and
perform, using the user dialog system, at least one of natural language understanding, automatic speech recognition, or text speech synthesis.

15. The apparatus of claim 13, wherein the instructions, when executed by the one or more processors individually or collectively, further cause the apparatus to:
customize at least one of an appearance, a pose, an emotional expression, or a voice of the virtual avatar is customized, based on the state decision data, the role type, and the current scenario type.

16. The apparatus of claim 12, wherein the attribute information comprises self-feature information of the virtual digital object and feature information of an environment where the virtual digital object is located, and
wherein the environment comprises at least one of a micro-environment or a macro-environment.

17. The apparatus of claim 12, wherein the instructions, when executed by the one or more processors individually or collectively, further cause the apparatus to:
identify a type of an entity corresponding to the virtual digital object;
obtain a corresponding set of object attributes based on the type of the entity; and
obtain corresponding attribute values for the virtual digital object based on attributes indicated by the corresponding set of object attributes, so as to obtain the attribute information of the virtual digital object.

18. The apparatus of claim 14, wherein the instructions, when executed by the one or more processors individually or collectively, further cause the apparatus to:
obtain the current state data of the virtual digital object based on at least one of the attribute information in a state inferring manner by using a preset knowledge base or rule base, or on the attribute information by using a pre-trained state inference model.

19. The apparatus of claim 14, wherein the instructions, when executed by the one or more processors individually or collectively, further cause the apparatus to:
obtain, by using a pre-trained state prediction model, the future state data of the virtual digital object based on at least one of the attribute information of the virtual digital object or historical attribute information of the virtual digital object within a specified historical time period.

20. The apparatus of claim 14, wherein the instructions, when executed by the one or more processors individually or collectively, further cause the apparatus to:
based on state data indicating that the virtual digital object is in an abnormal state, determine that the interaction with the user in the scenario needs to be triggered, the state data comprising the current state data and the future state data; and
based on a distance between the user and an entity corresponding to the virtual digital object being within a preset range, determine that the interaction with the user in the scenario needs to be triggered.
